(19) United States
(12) Patent Application Publication
(10) Pub. No.: US 2026/0052413 A1
(43) Pub. Date: Feb. 19, 2026

(54) Methods and Apparatuses for Reporting Quality of Experience Measurement for a Multicast Broadcast Service

(71) Applicant: Telefonaktiebolaget LM Ericsson (publ), Stockholm (SE)

(72) Inventors: Filip Barac, Huddinge (SE); Agne Ciuciulkaite, Uppsala (SE); Luca Lunardi, Genova (IT); Johan Rune, Lidingö (SE); Cecilia Eklöf, Täby (SE)

(21) Appl. No.: 19/100,634

(22) PCT Filed: Aug. 3, 2023
(86) PCT No.: PCT/SE2023/050772

§ 371 Date: Feb. 3, 2025

Related U.S. Application Data
(60) Provisional application No. 63/395,097, filed on Aug. 4, 2022.

(51) Int. Cl. H04W 24/10; H04W 4/06

(52) U.S. Cl. CPC H04W 24/10; H04W 4/06

(57) ABSTRACT

Embodiments described herein relate to methods and apparatuses for reporting Quality of Experience, QoE, measurements for a Multicast Broadcast Service, MBS. A method in a user equipment comprises receiving, from a network node, a configuration configuring the performing and/or reporting of QoE measurements of the MBS, wherein the configuration indicates that QoE measurements are to be performed and/or QoE reports are to be reported upon fulfilment of one or more conditions.

### TECHNICAL FIELD

Embodiments described herein relate to methods and apparatuses for configuring reporting and/or performing of Quality of Experience measurements.

### BACKGROUND

### Overview of the QoE Framework

Quality of Experience (QoE) measurements, also referred to as “application layer measurements”, have been specified for Long Term Evolution (LTE), Universal Mobile Telecommunications Service (UMTS) and were recently specified for 5G New Radio (NR) in the 3GPP Rel-17. The purpose of the QoE measurements is to measure the experience of the end user using certain applications. Currently the QoE measurements are specified and supported for Dynamic Adaptive Streaming over HTTP (DASH) streaming, Mobility Telephony Service for IMS (MTSI) services, and Virtual Reality (VR).

The solutions in LTE and UMTS are similar with the overall principles as follows. QoE Measurement Collection (QMC) enables configuration of application layer measurements in the user equipment (UE) and transmission of QoE measurement result files, commonly referred to as “QoE reports”, to the network by means of Radio Resource Control (RRC) signalling. An application layer measurement configuration (also called QoE measurement configuration or QoE configuration) that the Radio Access Network (RAN) receives from the Operations Administration and Management (OAM) system, or the Core Network (CN), is encapsulated in a transparent container, which is forwarded to a UE in a downlink RRCReconfiguration message. An application layer measurement report (also called QoE report) that the UE Access Stratum (UE AS) or UE RRC layer receives from the UE's higher layer (application layer) is encapsulated in a transparent container and sent to the network in an uplink RRC message, MeasurementAppLayerReport. The RAN then forwards the QoE report to a Measurement Collector Entity (MCE).

In 3GPP Rel-17 “Study on NR QoE management and optimizations for diverse services” the purpose to study solutions for QoE measurements in NR was finalized and concluded. According to this item, QoE management in NR will not just collect the QoE parameters of streaming services but also consider the typical performance requirements of diverse services (e.g. Augmented Reality and Virtual Reality (AR/VR) and Ultra Reliable Low Latency Communications (URLLC), of which at least VR was covered in 3GPP Rel-17). Based on requirements of services, the NR study also included more adaptive QoE management schemes that enable network optimization to satisfy user experience for diverse services.

The configuration data related to QoE measurements (in standard specifications typically referred to as application layer measurements) consists of a service type indication, an indication of an area in which the measurements are to be performed (denoted area scope), an IP address of the entity the collected measurement results (i.e. the QoE reports) may be sent to (often referred to as a MCE, spelled out as Measurement Collector Entity or Measurement Collection Entity) and a set of instructions of which type of measurements are to be performed and details of how these measurements are to be performed. These instructions are intended for the application layer in the UE and are placed in a “container” which cannot be read and interpreted by the network entities handling it, e.g., forwarding it to the UE, as well as the UE Access Stratum. The currently specified service types are MTSI and streaming service (DASH), and in 3GPP Rel-17, VR was added. An area scope may be defined in terms of cells or network related areas. In UMTS, an area scope may be defined as either a list of cells, a list of routing areas, or a list of tracking areas. In LTE, an area scope may be defined as either a list of cells or a list of tracking areas. In NR, an area scope will be defined as either a list of cells or a list of tracking areas.

QoE, and in particular, the QoE configuration may have one of at least two types: management-based (m-based) QoE configuration and signaling-based (s-based) QoE configuration. In both these examples the QoE configuration originates in the OAM system or some other administrational entity, e.g., dealing with customer satisfaction. All of these entities are in this document referred to as the OAM system (where the OAM system also contains further entities).

With the m-based QoE, the OAM system is typically interested in general QoE statistics from a certain area, configured as an area scope. The m-based QoE configuration may be sent directly from the OAM system to the RAN nodes controlling cells that are within the area scope. Each RAN node may then select UEs that are within the area scope (and also fulfils any other relevant condition, such as supporting the concerned application/service type) and sends the m-based QoE configuration to these UEs.

With the s-based QoE, the OAM system is interested in collecting QoE measurement results from a specific UE, e.g., because the user of the UE has filed a complaint. The OAM system sends the s-based QoE configuration to the HSS (in EPS/LTE) or UDM (in 5GS/NR), which forwards the QoE configuration to the UE's current core network node (CN), e.g. an Mobility Management Entity (MME) in EPS/LTE or an Access Management Function (AMF) in 5G/NR. The CN then forwards the s-based QoE configuration to the RAN node that serves the concerned UE and the RAN forwards it to the UE.

The service type indication and the container with the measurement instructions may also be forwarded to the UE. The UE is not aware of whether a received QoE configuration is m-based or s-based. In legacy systems, the QoE framework is integrated with a Trace functionality and a Trace ID is associated with each QoE configuration. In NR, the QoE functionality is logically separated from the Trace functionality, but it will still partly reuse the Trace signaling mechanisms. In NR, and possibly in LTE, a globally unique QoE reference (formed of Mobile Country Code (MCC)+Mobile Network Code (MNC)+QMC ID, where the QMC ID is a string of 24 bits) will be associated with each QoE configuration. The QoE reference may be included in the container with the measurement instructions and also sent to the RAN (i.e., the gNB in NR). For the communication between the gNB and the UE, the QoE reference may be replaced by a shorter identifier denoted as measConfigAppLayerId, which may be considered locally unique within a user equipment (UE) (e.g. there may be a one-to-one mapping between a measConfigAppLayerId and a QoE reference for each QoE configuration provided to a UE). The measConfigAppLayerId may be stored in the UE Access Stratum and may also be forwarded in an Attention (AT) Command (which is the type of instructions used in the communication between the UE's modem part and the UE's application layer) together with the service type indication and the container with the measurement instructions.

Reports of collected QoE reports are sent from the UE application layer to the UE Access Stratum, which may then forward them to the RAN. The RAN may then in turn forward the QoE reports to the MCE. These QoE reports may be placed in a “container”, which is uninterpretable for both the UE Access Stratum and the RAN. QoE reporting may be configured to be periodic or to only be sent at the end of an application session. Furthermore, the RAN may instruct the UE to pause QoE reporting, e.g. in case the cell/gNB is in a state of overload.

The RAN is not automatically aware of when an application session with an associated QoE measurement session is ongoing, and the UE Access Stratum is also not automatically aware of this. To alleviate this, session “start”/“stop” indications which are sent from the application layer in the UE to the UE AS and from the UE AS to the RAN were introduced. A session “stop” indication may be explicit or may be implicit in the form of a QoE report sent when the application session and the associated QoE measurement session are concluded.

The RAN may decide to release a QoE configuration in a UE at any time, as an implementation-based decision. Typically, a QoE configuration release may be performed when the UE has moved outside a configured area scope.

One opportunity provided by legacy solutions is also to be able to keep the QoE measurement for the whole session, even during a handover situation. It is also discussed to let the UE continue with the QoE measurements on an ongoing application session until the application session ends, even if the UE in the meantime moves out of the configured area scope.

### RAN Visible QoE (RVQoE)

An extension of the QoE framework, which has been studied for 3GPP release 17 and which was specified in 3GPP, is the concept of RAN visible QoE (RVQoE). The legacy QoE reports are intended for the MCE (which is an entity outside the RAN, e.g., a part of the OAM system), and the RAN receives such QoE reports from the UE in an RRC message in an opaque format, i.e., in a format not readable by RAN according to the current 3GPP TS 38.331 specification (although gNB/eNB implementations may allow to decode the opaque information). In contrast, reported RVQoE metrics are intended for the RAN and are delivered to the RAN in a format that the RAN understands. The RVQoE metrics are derived from the legacy QoE metrics, collected, and compiled in reports by the UE application layer. These RVQoE reports are delivered to the RAN, which may use them for diverse types of optimizations. For example, when the RAN receives RVQoE reports during an ongoing application session, the RAN may then perform adaptive actions to impact the QoE of the concerned application session while the application session is ongoing, such as change various parameters related to the scheduling of the UE and the data flows related to the application session. According to current 3GPP Release 17 TS 38.423 (Section 9.2.3.158), the available RAN visible QoE metrics are Buffer Level and Playout Delay for Media Startup which are available for DASH streaming and VR service types.

### Multicast and Broadcast Service Overview

Multicast and Broadcast Service (MBS) is a point-to-multipoint service in which services and data are transmitted from a single source entity to multiple recipients. For example, an broadcast MBS communication may transmit to all UEs in a Broadcast service area, and a multicast MBS communication may transmit to users in a multicast group as defined in 3GPP TS 23.247 v 18.0.0.

5G NR system enables delivery of Multicast Broadcast Service (MBS) in a resource-efficient way. Via the MBS, the same service and the same specific content data from a single source can be provided simultaneously to all UEs in a geographical area (in the broadcast communication service) or to a dedicated set of UEs (in the multicast communication service). That is, all UEs in a broadcast area can receive the data, while not all UEs are authorized to receive the data in a multicast area.

A UE can receive a broadcast MBS communication service independently of its RRC state, while a multicast MBS service may be received only by the UEs in the RRC_CONNECTED state. Multicast communication data may be delivered to a UE via Point-to-Point (PTP) and/or Point-To-Multipoint (PTM) mechanisms, and Hybrid Automatic Retransmission Request (HARQ) retransmission/feedback may be applied to both of these mechanisms, as specified in 3GPP TS 38.300 v 17.1.0.

FIG. 1 illustrates MBS delivery methods as shown in 3GPP TS 23.247 v 18.0.0.

For a multicast communication service, shared and individual delivery modes are specified in 3GPP TS 23.247 v 18.0.0. Between 5G core (5GC) and NG-RAN, there may be two possible delivery methods to transmit the MBS data:
5GC Individual MBS traffic delivery method: This method may only be applied for multicast MBS sessions. 5GC receives a single copy of the MBS data packets and delivers separate copies of those MBS data packets to individual UEs via per-UE Protocol Data Unit (PDU) sessions, hence for each such UE one PDU session may be required to be associated with a Multicast MBS session. The MBS data received by the Multicast and Broadcast User Plane function (MB-UPF) is replicated towards the UPF(s) where individual delivery may be performed via unicast transport over an N19mb interface.
5GC Shared MBS traffic delivery method: This method may be applied for both broadcast and multicast MBS sessions. 5GC receives a single copy of MBS data packets and delivers a single copy of those MBS packets to an NG-RAN node, which then delivers the packets to one or multiple UEs. These incoming MBS traffic packets may be delivered from Multicast and Broadcast User Plane function (MB-UPF) to NG-RAN node via an N3mb interface.

The 5GC Shared MBS traffic delivery method may be required in all MBS deployments. The 5GC Individual MBS traffic delivery method may be required to enable mobility when there is an NG-RAN deployment with non-homogeneous support of MBS.

Between the NG-RAN and the UE, there may be two example delivery methods that are available for the transmission of MBS data packets over radio interface:

1) Point-to-Point (PTP) delivery method: In this method the NG-RAN delivers separate copies of MBS data packets over radio interface to individual UE(s).

2) Point-to-Multipoint (PTM) delivery method: In this method the NG-RAN delivers a single copy of MBS data packets over radio interface to multiple UEs.

In some examples, the NG-RAN may use a combination of PTP/PTM to deliver an MBS data packets to UEs.

### MBS Radio Bearer

An MBS Session Resource may be associated with one or more MBS QoS flows, and each of those flows may be associated with a QoS profile. A gNB may provide one or more multicast MBS Radio Bearer (MRB) configurations to the UE via RRC signalling, as described in TS 38.300 v 17.1.0, clause 16.10.3. For a multicast session, a gNB may change the (MRB) type using RRC signalling. For a broadcast session, a gNB may provide a broadcast MRB with one Downlink (DL)-only Radio Link Control Unacknowledged Mode (RLC-UM) entity for PTM transmission, i.e. only one type of an MRB is specified at the moment for the broadcast communication transmission. Network and protocol architectures are described in detail in 3GPP TS 38.300 v 17.1.0 chapters 16.10.2 and 16.10.3.

### Group Scheduling and Group Paging

Group scheduling mechanisms for MBS delivery are described in 3GPP TS 38.300 v 17.1.0, clause 16.10.4. For a multicast communication service, shared and individual delivery modes are specified in 3GPP TS 23.247 v 18.0.0. RNTI is used for the group transmission where a UE may receive different services using the same or different Global Radio Network Temporary Identifier(s) (G-RNTI(s)) or Global Configured Scheduling Radio Network Temporary Identifier(s) (G-CS-RNTIs), as defined in 3GPP TS 38.300 v 17.1.0. NG-RAN performs certain functions to support MBS. They may include management of MBS QoS flows, delivery of MBS data packets from 5GC to multiple UEs via PTP or PTM, configuration of UE for MBS QoS flow reception at the Access Stratum (AS) layer, controlling switching between PTM and PTP delivery per UE, support for multicast session service continuity during Xn and NG handovers, and support for group paging at multicast session activation over radio toward UEs in CM-IDLE state and CM-CONNECTED with RRC INACTIVE state.

### MBS Interest Indication

To ensure service continuity of MBS broadcast, a UE in RRC_CONNECTED state may send an MBS Interest Indication to the gNB, comprising of the following information:
1) A list of MBS frequencies UE is interested in receiving, sorted in decreasing order of interest
2) An indication of priority between the reception of all listed MBS frequencies and the reception of any unicast bearer
3) A list of MBS broadcast services the UE is interested in receiving, in case SIB20 is scheduled by the UE's PCell.
4) The UE's priority to MBS broadcast versus unicast reception.

MBS Interest Indication information reporting may be implicitly enabled/disabled by the presence of a system information block (e.g SIB21).

### Mobility Support During an MBS Session

Mobility support for service continuation when a UE is in an MBS session depends on whether a broadcast or multicast session is taking place, and on whether the source and target nodes support MBS. For the multicast MBS session, three cases may be distinguished: 1) handover (HO) from an NG-RAN node supporting MBS to a node not supporting MBS, 2) handover from an NG-RAN node not supporting MBS to a node supporting MBS, and 3) a handover from a node supporting MBS to another node supporting MBS.

In the Multicast MBS case:
a. when the HO takes place from a node that supports MBS to a node that does not support MBS, or vice versa, the 5GC Shared MBS Traffic Delivery and 5GC Individual Traffic delivery methods may co-exist temporarily upon handover. Mapping information about unicast QoS flows for multicast data transmission and the information of associated multicast QoS flows are provided to an NG-RAN node. The delivery method is switched from 5GC Shared MBS Traffic delivery to 5GC Individual MBS delivery via establishing the N3 tunnel of the PDU Session for Individual delivery. SMF realizes that the target node does not support MBS. A GTP tunnel between the UPF and the MB-UPF for 5GC Individual MBS traffic delivery activated by SMF and MBS-SMF.
b. When the HO takes place from a RAN node that supports MBS to another node that also supports MBS, if the shared delivery for the MBS session has not been established towards the target NG-RAN node, it uses MB-SMF (Multicast Broadcast Session Management Function) and MB-UPF (Multicast Broadcast User Place Function) to establish the Shared delivery for the MBS session. The PDU Sessions, including the one associated with the MBS Multicast session and used for the 5GC Individual MBS traffic delivery, are handed over to the target ND-RAN node. The SMF may trigger the mode switch from the Individual to the Shared delivery mode. The target node may establish the shared delivery for the MBS Session upon receiving the MBS Session Context. 5GC Individual MBS traffic delivery may be terminated by 5GC and changed to the 5GC shared MBS traffic delivery.

In the Broadcast MBS case:
a. The UE may receive the same service in the target node (which supports MBS) if the same MBS session is established with the 5GC Shared MBS traffic delivery. Currently, a case of when a UE is handed over to a node not supporting the MBS within the broadcast area, is not specified.

### QoE and RVQoE Metrics for MBMS

The 3GPP TS 26.346 v 17.1.0 defines QoE metrics for the Multimedia Broadcast Multicast Service (MBMS), in addition to QoE metrics for DASH streaming that can also be used. The full table from TS 26.346 v 17.1.0 is presented below for reference.

According to current 3GPP TS 38.423 v17.0.0, clause 9.2.3.158, the available RAN visible QoE metrics are Buffer Level and Playout Delay for Media Startup which are available for DASH streaming and VR service types.

| | Streaming | Download | |
|---|---|---|---|
| | delivery | delivery | Metric |
| QoE Metric | method | method | type |
| Corruption duration metric | ✓ | | Media |
| Rebuffering duration metric | ✓ | | Session |
| Initial buffering duration metric | ✓ | | Session |
| Successive loss of RTP packets | ✓ | | Media |
| Frame rate deviation | ✓ | | Media |
| Jitter duration | ✓ | | Media |
| Content Access/Switch Time | ✓ | | Session |
| Network Resource | ✓ | ✓ | Session |
| Average codec bitrate | ✓ | | Media |
| Codec information | ✓ | | Media |
| Loss of Objects | | ✓ | Session |
| Distribution of Symbol Count | | ✓ | Session |
| Underrun for Failed Blocks | | | |

### RVQoE Metrics for at Application Layer:

As one option, or for some RVQoE metrics, the UE AS may forward RVQoE metrics received from the UE Application Layer to the RAN without modification or additions:

One or more (raw) QoE metrics may be measured at the UE Application Layer, and subsequently:
a. The QoE metrics may be sent from the Application Layer of the UE to the UE Access Stratum, in a format (e.g., RRC format) that the UE AS can easily include in, or convert into, a field in an RRC message. The information obtained from the raw QoE metrics and included in the RRC message may comprise the RAN Visible QoE metrics
b. The RAN Visible QoE metrics may then be sent from the UE RRC layer to RAN, without modification at UE Access Stratum.

### RVQoE Metrics at Access Stratum Layer:

As another option, or for some RVQoE metrics, the UE AS may modify or adds to the RVQoE metrics received from the UE Application Layer before forwarding them to the RAN

One or more (raw) QoE metrics may be measured at UE Application Layer, and subsequently:
a. The QoE metrics may be sent from the Application Layer of the UE to the UE Access Stratum, in a format (e.g., RRC format) that the UE AS can easily include in, or convert into, a field in an RRC message). The information obtained from the raw QoE metrics and, via the described steps, included in the RRC message constitutes the RAN Visible QoE metrics
b. Before sending the RAN Visible QoE metric to the RAN, the RAN Visible QoE metrics as received from the Application Layer, may be modified by the UE Access Stratum
c. The obtained version of the RAN Visible QoE metrics may then be sent from the UE RRC layer to RAN.

### RVQoE Values (or RVQoE Scores) at Application Layer:

RAN-visible QoE values are a set of values derived from raw QoE metrics through a model/function.

One or more representations (mapping) of (raw) QoE metrics may be measured at UE Application Layer, and subsequently:
a. The representations may be sent from the Application Layer of the UE to the UE Access Stratum, e.g., in RRC format (e.g., in a format that the UE AS can easily include in, or convert into, a field in an RRC message)
b. The representations may then be sent from the UE RRC layer to RAN without modification at UE Access Stratum.

### RVQoE Values (or RVQoE Scores) at Access Stratum:

One or more representations (mapping) of (raw) QoE metrics are measured at UE Application Layer, and subsequently:
a. The representations may be sent from the Application Layer of the UE to the UE Access Stratum in RRC format (e.g., in a format that the UE AS can easily include in, or convert into, a field in an RRC message)
b. The representations may then be modified by the UE Access Stratum
c. The modified version of the representations may then be sent from the UE RRC layer to RAN.

### 3GPP Rel-18 QoE Work Item

For 3GPP Rel-18, the RP-221803 describes the Work Item “Enhancement on NR QoE management and optimizations for diverse services” and among others, it indicates, the following objectives:

“Support for new service type, such as AR, MR, MBS and other new service type defined or to be supported by SA4. Support RAN-visible parameters for the additional service types, and the existing service if needed, and the coordination with SA4 is needed [RAN3, RAN2].

Specify the new service and the existing service defined or to be supported by SA4, combined with high mobility scenarios, e.g., High Speed Trains.

Specify for QoE measurement configuration and collection in RRC_INACTIVE and RRC_IDLE states for MBS, at least for broadcast service [RAN3, RAN2].

Specify the mechanism to support the alignment of the existing radio related measurement and QoE reporting.

Left-over features from Rel-17, as well as the enhancements of existing features which are not included in Rel-17 normative phase, should be supported in Rel-18 if consensus on benefits are reached [RAN3, RAN2].

Specify per-slice QoE measurement configuration enhancement.

Specify RAN visible QoE enhancements for QoE value, RAN visible QoE trigger event, RAN visible QoE Report over F1.

Specify QoE reporting handling enhancement for overload scenario”

### Summary

There currently exist certain challenge(s).

According to the 3GPP Rel-18 QoE Work Item Description in RP-221803, 3GPP Rel-18 will standardize the support for QoE measurement collection (QMC) for a range of new 5G service types, including Multicast Broadcast Service (MBS). MBS as a service type was specified for NR (3GPP TS 23.247).

According to published technology, there is limited control in configuring and reporting QoE/RVQoE for MBS, namely the QoE and RVQoE measurements must proceed during the entire MBS session, or until they are interrupted by the network.

### Summary

Certain aspects of the disclosure and their embodiments may provide solutions to these or other challenges.

In particular, embodiments described herein provide methods and apparatuses for supporting trigger- and event-based QoE and RVQoE measurement configuration and reporting for MBS. Embodiments described herein propose MBS-specific QoE and RVQoE metrics and related events, which, upon occurring instantaneously or upon fulfilling defined conditions, may trigger immediate QoE and RVQoE measurement, reporting or logging of the QoE and RVQoE values. The conditions may be, for example, a change in a UE's RRC state or data delivery method or achieving a threshold number of occurrences of a specific event etc.

Certain embodiments may provide one or more of the following technical advantage(s). Embodiments described herein allow network operators a finer and more flexible control of the execution of QoE and RVQoE measurements and reporting for MBS service. This flexibility allows to focus QoE and RVQoE measurements for MBS related to events or scenarios that are of interest for a network operator. Focusing only on “interesting” events and scenarios reduces the network's processing load of the QoE measurements and the UE processing load to perform the measurements, this will then reduce UE energy consumption.

According to some embodiments there is provided a method performed by a user equipment for reporting Quality of Experience measurements for a Multicast Broadcast Service, MBS. The method comprises receiving, from a network node, a configuration configuring the performing and/or reporting of QoE measurements of the MBS, wherein the configuration indicates that QoE measurements are to be performed or QoE reports are to be reported upon fulfilment of one or more conditions.

According to some embodiments there is provided a method performed by a network node for configuring reporting Quality of Experience measurements for a Multicast Broadcast Service, MBS. The method comprises transmitting, to a user equipment, a configuration configuring the performing and/or reporting of QoE measurements of the MBS, wherein the configuration indicates that QoE measurements are to be performed or QoE reports are to be reported upon fulfilment of one or more conditions.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates MBS delivery methods as shown in 3GPP TS 23.247

FIG. 2 illustrates a method in accordance with some embodiments;

FIG. 3 illustrates a method in accordance with particular embodiments;

FIG. 4 shows an example of a communication system 400 in accordance with some embodiments;

FIG. 4 shows an example of a communication system 400 in accordance with some embodiments;

FIG. 5 shows a UE 500;

FIG. 6 shows a network node 600 in accordance with some embodiments;

FIG. 7 shows a host 700 in accordance with some embodiments;

FIG. 8 shows a virtualization environment 800 in which functions implemented by some embodiments may be virtualized; and

FIG. 9 shows a communication diagram of a host 902 communicating via a network node 904 with a UE 906 over a partially wireless connection in accordance with some embodiments.

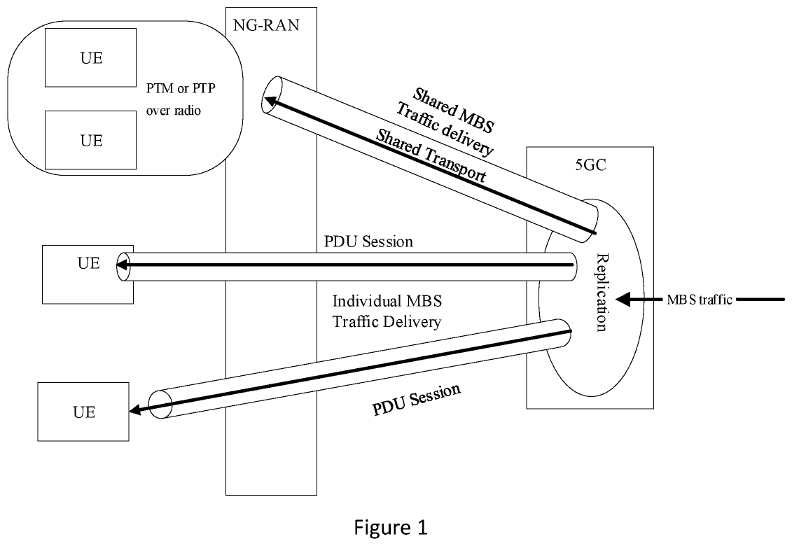

### ADDITIONAL EXPLANATION

Some of the embodiments contemplated herein will now be described more fully with reference to the accompanying drawings. Embodiments are provided by way of example to convey the scope of the subject matter to those skilled in the art.

### Terminology, Disclaimers, and Generalizations

The terms “application layer measurement configuration”, “application measurement configuration”, “QoE measurement configuration”, “QoE configuration”, “QoE measurement and reporting configuration” and “QMC configuration” are used interchangeably. But note that the “QMC configuration file” is not an equivalent term, but instead refers to the part of the QoE configuration consisting of an XML file containing instructions of QoE metrics to be collected etc.

The terms “QoE report” and “QoE measurement report” are used interchangeably. Similarly, the terms “RAN Visible QoE report”, “RAN Visible QoE measurement report”, “RVQoE report” and “RVQoE measurement report” are used interchangeably.

The terms “access stratum” and “radio layer” are used interchangeably when referring to a UE.

The term “session” may refer to either a QoE measurement session or an application session or an application session for which QoE measurement is applied.

The term “session” may refer to either a QoE measurement session or an application session or an application session for which QoE measurement is applied.

The term “RVQoE value” refers to a set of values derived from QoE metrics data through a model/function defined in collaboration with SA4, as defined in 3GPP TR 38.890.

The term “unicast delivery” is not equivalent to “5GC Individual MBS traffic delivery” method. As defined in 3GPP TS 23.247, the unicast delivery refers to a mechanism by which application data and signalling between a UE and the application server addresses between the 3GPP network and the application server.

The term “MBS QoS Flow” is the finest granularity for QoS forwarding treatment for MBS data. Providing different QoS forwarding treatment requires separate MBS QoS Flows in 5GS supporting MBS.

The solution proposed in embodiments described herein applies to UMTS, LTE and NR as well as future RATs such as 6G.

All the indications proposed in the embodiments described herein, when applicable to RVQoE measurements, can be implemented as parameters in RRC format (e.g., in a format that the UE AS can easily include in, or convert into, a field in an RRC message), as parameters of an AT command, as values of an information element (e.g., Service type) of a RAN protocol (e.g., NGAP (NG Application Protocol), XnAP (Xn Application Protocol).
For example, the <app-meas_service_type>parameter indicating what application is the target for the application level measurement configuration may have a numerical value (integer) mapped to “QoE measurement collection for MBS”.

Herein, the term MBS may be utilized to encompass any form of multicast or broadcast communication. In particular herein the terms MBS multicast communication, MBS Multicast Service, Multicast Service, Multicast delivery and Multicast may be considered equivalent. Similarly, the terms MBS Broadcast communication, MBS Broadcast Service, Broadcast Service, Broadcast delivery, and Broadcast may be considered equivalent.

In embodiments described herein the network may configure a UE with a set of one or more conditions or events, upon the fulfilment of which the UE may commence or end performing QoE measurements (where QoE measurements may comprise RVQoE measurements)) and/or reporting for an MBS.

Unless otherwise stated, all considerations in the embodiments described herein may be applied equally to both QoE and RVQoE measurements for MBS.

Unless otherwise stated, all considerations in the embodiments described herein may be applied equally to both starting and ending QoE measurements for MBS.

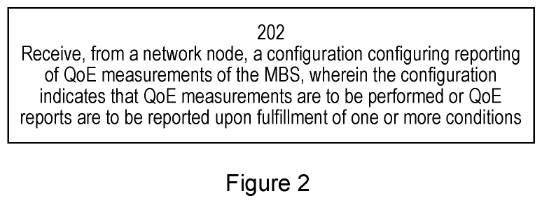

FIG. 2 illustrates a method in accordance with some embodiments.

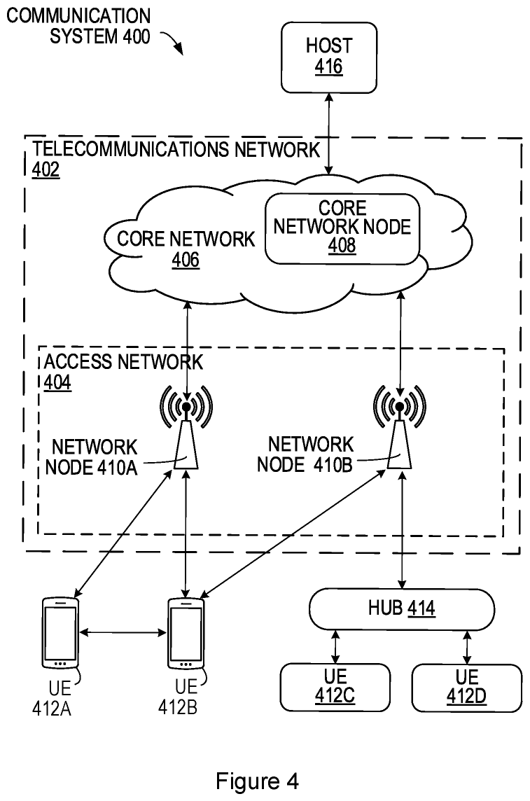

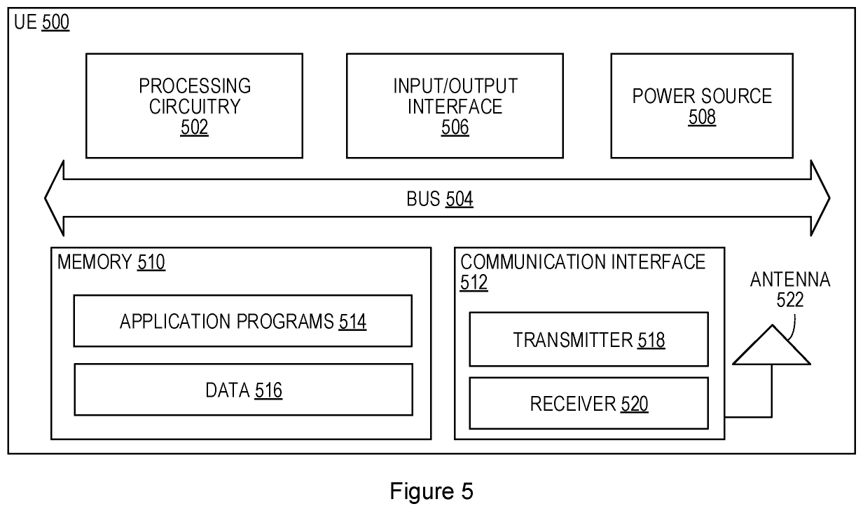

FIG. 2 depicts a method in accordance with particular embodiments. The method 2 may be performed by a UE or wireless device (e.g. the UE 412 or UE 500 as described later with reference to FIGS. 4 and 5 respectively). The method begins at step 202 with receiving, from a network node, a configuration configuring reporting of QoE measurements of the MBS, wherein the configuration indicates that QoE measurements are to be performed upon fulfilment of one or more conditions.

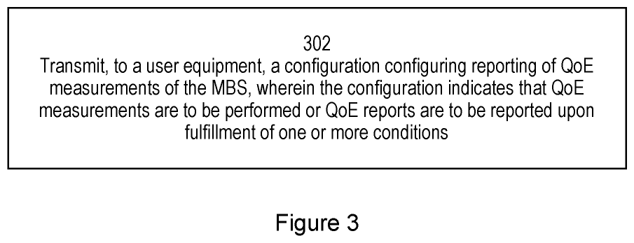

FIG. 3 illustrates a method in accordance with some embodiments.

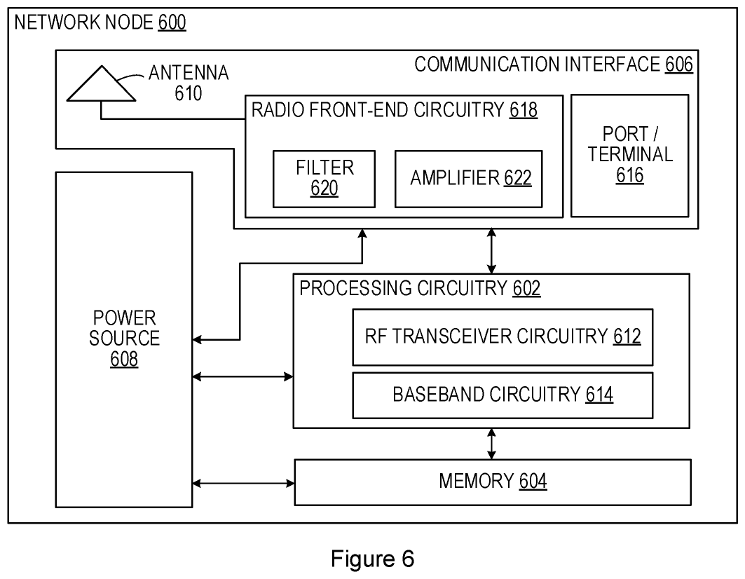

FIG. 3 depicts a method in accordance with particular embodiments. The method 3 may be performed by a network node (e.g. the network node 410 or network node 600 as described later with reference to FIGS. 4 and 6 respectively). The method begins at step 302 with transmitting, to a user equipment, a configuration configuring reporting of QoE measurements of the MBS, wherein the configuration indicates that QoE measurements are to be performed upon fulfilment of one or more conditions.

In general, the QoE and RVQoE measurement and reporting is executed at a certain periodicity. However, it is beneficial to execute QoE and RVQoE measurement and/or reporting only when certain conditions of interest are fulfilled. According to the methods 2 and 3, in the case of MBS, the network may configure the UE to start or end the QoE and RVQoE measurements and/or reporting (by sending the QoE and RVQoE report to the network) when a certain condition is fulfilled, or certain (multiple) conditions are fulfilled, and/or to include in the logged information (e.g., in the report which may be sent later) an indication that the condition(s) has/have been fulfilled (e.g., that a certain event has occurred). Such a condition or conditions may be one or more or any combination of the following (listed in paragraphs [00108] to [00151]:
a condition that a particular type of service (also referred to as a particular service type) is being transmitted via an MBS session, e.g., DASH streaming, public safety and mission critical, V2X applications, IPTV, live video, software delivery over wireless and IoT applications.
a condition that there is a possibility for the UE to use certain features for sending QoE/RVQoE reports, such as Small Data Transmission (SDT)
a condition that the UE is in a certain RRC state or transfers to/from a certain RRC state: If the UE can receive the MBS transmission in all the RRC states, that is, RRC_INACTIVE, RRC_IDLE, and RRC_CONNECTED states, the network may configure the UE to execute actions pertaining to the QoE and RVQoE measurement and/or reporting for MBS based on the RRC state during the MBS service. In that respect, the UE may be configured to do one or more of the following:
   a. Execute QoE and/or RVQoE measurements and/or send the QoE and/or RVQoE reports when the application session starts while the UE is in a certain RRC state. Optional restriction to RRC INACTIVE and RRC_IDLE states, to avoid UE transitioning into a RRC_CONNECTED state. The restriction may not apply for sending QoE/RVQoE reports in case SDT can be used for transmitting such QoE/RVQoE reports.
   b. Execute QoE and/or RVQoE measurements and/or send the QoE reports when the UE is in a certain RRC state. Optional restriction to RRC INACTIVE and RRC_IDLE states, to avoid UE transitioning into a RRC_CONNECTED state. The restriction may not apply for sending QoE/RVQoE reports in case SDT can be used for transmitting such QoE/RVQoE reports.
   c. Execute QoE and/or RVQoE measurements and/or send the QoE and/or RVQoE reports upon/during/after specific RRC state transitions or any RRC state transition. Optionally, when the UE is in RRC_IDLE or RRC_INACTIVE state, to avoid triggering that the UE enters RRC_CONNECTED state to send a report, it may be preferable that this triggering event is used to trigger the UE to include in the information to be sent in a report (e.g., the logged information), an indication of the occurred event and possibly other more or less related information, such as the number of blind/proactive retransmissions that were required for correct reception/decoding, and/or the current buffer level e.g. in case MBS is used to convey video content.
   d. As a further option, the trigger-event may be configured in a way that the UE is implicitly or explicitly instructed to let fulfilment of the trigger-event trigger sending of a QoE and/or RVQoE report when the UE is in RRC_CONNECTED state while fulfilment of the trigger-event when the UE is in RRC_IDLE or RRC_INACTIVE state triggers the UE to include certain information (e.g. an indication that the trigger-event has occurred and possibly further information as described above) in the logged information to be reported later.
A condition that a specific MBS delivery mode is used, e.g., when Broadcast is used, when Multicast is used, or when either Broadcast or Multicast is used. For example, when any of Broadcast, Multicast, is used, triggers/conditions can be associated to an MBS session, such as:
   a. Enabling QoE and/or RVQoE measurements when a Multicast session is created/established;
   b. Enabling QoE and/or RVQoE measurements when a Broadcast session is created/established
   c. Disabling QoE and/or RVQoE measurements when a Multicast session is deleted/released
   d. Disabling QoE and/or RVQoE measurements when a Broadcast session is deleted/released
   e. Enabling QoE and/or RVQoE reporting when a Multicast session is created/established
   f. Enabling QoE and/or RVQoE reporting when a Broadcast session is created/established
   g. Disabling QoE and/or RVQoE reporting when a Multicast session is deleted/released
   h. Disabling QoE and/or RVQoE reporting when a Broadcast session is deleted/released
   i. Triggering the QoE and/or RVQoE reporting when a Multicast session is deleted/released
   j. Triggering the QoE and/or RVQoE reporting when a Broadcast session is deleted/released
a condition that certain behavior of a UE or group of UEs occurs, such as:
   a. Triggering the start/resume of QoE and/or RVQoE measurements for a UE upon receiving an indication that UE joined a Multicast session. In one variant, the triggering occurs when the UE joins the Multicast session and there is no data packet sent to the UEs (MBS session is created, but no data transfer is ongoing when the indication that UE joining the Multicast session arrives). In another variant, the triggering occurs when the UE joins the Multicast session and there is data packet sent to the UE (MBS session is created, and data transfer is ongoing when the indication that UE joining the Multicast session arrives)
   b. Triggering the stop/pause of QoE and/or RVQoE measurements for a UE upon receiving an indication that UE left a Multicast session. In one variant, the triggering occurs when the UE leaves the Multicast session and there is no data packet transmission for the Multicast session (the Multicast session is ongoing, but no data transfer is transferred to any UEs when the indication that a specific UE leaving the Multicast session is received). In another variant, the triggering occurs when the UE leaves the Multicast session and there is still data packet transmission for the Multicast session (the Multicast session is ongoing, and data transfer is ongoing for the session when the indication that UE joining the Multicast session arrives)
   c. Triggering the start/resume in the sending of QoE and/or RVQoE report upon receiving an indication that a UE has left a Multicast session
   d. Triggering the QoE and/or RVQoE reporting for a UE or a group of UEs upon completing the sending (in DL) of certain packet within a Multicast session/Broadcast session
a condition that QoE measurements are executed and/or QoE reports are transmitted upon/during/after a switch between Broadcast, Multicast, and/or Unicast traffic delivery modes for the ongoing MBS session
a condition that a certain frequency starts or stops being used for the MBS session
a condition that PTP is used, PTM is used, or either PTP and/or PTM is used for data delivery
a condition that QoE measurements are executed and/or QoE reports are transmitted upon/during/after a switch between PTP to PTM for the MBS session occurs
a condition that a number of switches from PTP to PTM (or vice versa) is exceeded, or until it is reached or exceeded. Where the number of switches is:
   a. Optionally, counted over the entire MBS session
   b. Optionally, counted since the start of the MBS session
   c. Optionally, counted over the last time period of a certain duration D
   d. Optionally, represented as an average number of switches per time period
   e. Optionally, indication(s) of the number of packets or amount of data received between each two switches
a condition that a threshold for one or more QoE metrics for MBS has been reached/surpassed
a condition that a threshold for one or more RVQoE metrics for MBS has been reached/surpassed
a condition that a threshold for one or more RVQoE values for MBS has been reached/surpassed
a condition that switching from MRB to DRB occurs
a condition that a certain number of packets or amount of data is received or not yet received using PTP and/or PTM
a condition that QoE measurements are executed and/or QoE reports are transmitted upon/during/after a switch from Multicast to Unicast for an MBS session, or vice versa;
   a. In one case, upon/during/after a change occurs in an indication, from a first value indicating Multicast delivery, to a second value indicating Unicast delivery for the MBS session
   b. In another case, upon/during/after a switch from MRB to DRB, and/or vice versa, occurs during the MBS session
a condition that QoE measurements are executed and/or QoE reports are transmitted Upon/during/after a switch from Multicast to Broadcast for an MBS session, or vice versa
a condition that QoE measurements are executed and/or QoE reports are transmitted upon/during/after the switch from Broadcast to Unicast for an MBS session,
a condition that a certain number of packets or amount of data is received or not yet received using MRB and/or DRB. As an option, the counting of the number of received packets or amount of received data may reset after each switch from MRB to DRB, or vice versa
a condition that HARQ retransmissions are used (e.g., in conjunction with PTP and/or PTM), and/or after a certain number of retransmissions are executed;
   a. The number of retransmissions may be counted for a single data packet (i.e., the counting is restarted every time new data is transmitted) or
   b. The number of retransmissions may be counted for a set, e.g., N, of sequential data packets
a condition that HARQ retransmissions are used (e.g., in conjunction with PTP and/or PTM), and the average number of retransmissions reaches or exceeds a certain threshold
   a. As one option, the average is a moving average counted over the last N data packets (e.g., sets of retransmissions)
   b. As another option, the average is an exponential moving average calculated over sequential data packets
   c. The number of retransmissions may be counted for a single data packet (i.e., the counting is restarted every time new data is transmitted) or
   d. The number of retransmissions may be counted for a set, e.g., N, of sequential data packets
A condition that HARQ retransmissions are used (e.g., in conjunction with PTP and/or PTM), and the average number of retransmissions reaches or exceeds a certain threshold
   a. As one option, the average is a moving average counted over the last N data packets (e.g., sets of retransmissions)
   b. As another option, the average is an exponential moving average calculated over sequential data packets
A condition that a certain number of proactive/blind retransmissions have been executed during the broadcast MBS session
   a. Optionally, reporting can be restricted to RRC CONNECTED state
   b. Optionally, logging can be performed when a UE is in the RRC INACTIVE and/or RRC IDLE state
A condition that, when in MBS broadcast mode, at least a threshold number of blind/proactive retransmissions were needed for correct reception/decoding in the UE
   a. As one option, the required blind/proactive retransmissions are counted per packet (i.e., the counting is restarted for each new packet)
   b. As another option, the required blind/proactive retransmissions are counted for a set, e.g., N, of sequential data packets
   c. As yet another option, the required blind/proactive retransmissions compared with the threshold number is calculated as an average over a set, e.g., N, of sequential data packets, or calculated as an average over a certain time period.
   d. As yet another option, the required blind/proactive retransmissions compared with the threshold number is calculated as a sliding average counted over the last N data packets
   e. As yet another option, the required blind/proactive retransmissions compared with the threshold number is an exponential average calculated over sequential data packets
A condition that, when in MBS broadcast mode, the average number of blind/proactive retransmissions needed for correct reception/decoding in the UE reaches or exceeds a threshold
   a. As one option, the average is a moving average counted over the last N data packets (e.g., sets of retransmissions)
   b. As another option, the average is an exponential moving average calculated over sequential data packets
   c. As yet another option, the required blind/proactive retransmissions compared with the threshold number is calculated as a moving average counted over the last N data packets
   d. As yet another option, the required blind/proactive retransmissions compared with the threshold number is an exponential moving average calculated over sequential data packets
A condition that a number of packets the UE failed to receive is reached/exceeded or until it is reached/exceeded:
   a. During certain time periods
   b. On average per duration D
   c. On average during the MBS session
   d. On average during the duration covered by the QoE and RVQoE report.
A condition that a certain packet loss rate is reached/exceeded or until it is reached/exceeded:
   a. During certain time periods
   b. On average per duration D
   c. On average during the MBS session
   d. On average during the duration covered by the QoE and RVQoE report.
A condition that 5GC Shared MBS traffic delivery or 5GC Individual MBS traffic delivery, or both, start or stop being used
A condition that traffic delivery changes from 5GC Shared MBS to 5GC Individual, or vice versa
A condition that the QoE measurements are performed/QoE reports are transmitted upon handover (independently on whether a UE is in a unicast, multicast, or broadcast MBS session).
   a. A condition that the UE is handed over from a RAN node supporting MBS to a RAN node that does not support MBS, or vice versa
   b. A condition that the UE is handed over from a RAN node supporting MBS to another RAN node supporting MBS
A condition that the UE selects a cell supporting MBS, e.g. at initial cell selection.
A condition that the UE re-selects to a cell supporting MBS, i.e., due to mobility in RRC_INACTIVE or RRC_IDLE.
   a. It will be appreciated that the support of MBS may be at a RAN node level, so every cell of the RAN node supports MBS, or at a cell level, so one cell of a RAN node can support MBS and another cell of the same RAN node does not support MBS.
A condition that a UE applies the broadcast MRB establishment or the broadcast MRB release procedure to start or stop receiving an MBS session of a MBS broadcast service of interest, respectively
A condition that a UE joins or leaves a Multicast MBS session
A condition that a UE uses dual connectivity
A condition that a UE starts or stops using dual connectivity
A condition that duplication starts or stops being used
A condition that a period during which duplication was used exceeds a certain time,
A condition that a period during which duplication was not used exceeds a certain defined time
A condition that an RRC setup procedure is triggered for the UE.
A condition that an RRC re-establishment occurs.
A condition that the radio quality of the UE is below or above a certain threshold.
A condition that the buffer level in the UE is below or above a certain threshold.
A condition that the number of buffer level entries exceeds a certain number of entries
   Any of the above may be combined to a composite trigger event for performing/initiating certain QoE and/or RVQoE measurements and/or for reporting QoE and/or RVQoE measurement results. The combining of events/conditions may be achieved using logical AND operations, logical OR operations and/or logical XOR (i.e., exclusive OR) operations.

FIG. 4 shows an example of a communication system 400 in accordance with some embodiments.

In the example, the communication system 400 includes a telecommunication network 402 that includes an access network 404, such as a radio access network (RAN), and a core network 406, which includes one or more core network nodes 408. The access network 404 includes one or more access network nodes, such as network nodes 410a and 410b (one or more of which may be generally referred to as network nodes 410), or any other similar 3^{rd} Generation Partnership Project (3GPP) access node or non-3GPP access point. The network nodes 410 facilitate direct or indirect connection of user equipment (UE), such as by connecting UEs 412a, 412b, 412c, and 412d (one or more of which may be generally referred to as UEs 412) to the core network 406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 400 may include any number of wired or wireless networks, network nodes, UEs, and/or any other components or systems that may facilitate or participate in the communication of data and/or signals whether via wired or wireless connections. The communication system 400 may include and/or interface with any type of communication, telecommunication, data, cellular, radio network, and/or other similar type of system.

The UEs 412 may be any of a wide variety of communication devices, including wireless devices arranged, configured, and/or operable to communicate wirelessly with the network nodes 410 and other communication devices. Similarly, the network nodes 410 are arranged, capable, configured, and/or operable to communicate directly or indirectly with the UEs 412 and/or with other network nodes or equipment in the telecommunication network 402 to enable and/or provide network access, such as wireless network access, and/or to perform other functions, such as administration in the telecommunication network 402.

In the depicted example, the core network 406 connects the network nodes 410 to one or more hosts, such as host 416. These connections may be direct or indirect via one or more intermediary networks or devices. In other examples, network nodes may be directly coupled to hosts. The core network 406 includes one more core network nodes (e.g., core network node 408) that are structured with hardware and software components. Features of these components may be substantially similar to those described with respect to the UEs, network nodes, and/or hosts, such that the descriptions thereof are generally applicable to the corresponding components of the core network node 408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 416 may be under the ownership or control of a service provider other than an operator or provider of the access network 404 and/or the telecommunication network 402, and may be operated by the service provider or on behalf of the service provider. The host 416 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 400 of FIG. 4 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 402 is a cellular network that implements 3GPP standardized features. Accordingly, the telecommunications network 402 may support network slicing to provide different logical networks to different devices that are connected to the telecommunication network 402. For example, the telecommunications network 402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 412 are configured to transmit and/or receive information without direct human interaction. For instance, a UE may be designed to transmit information to the access network 404 on a predetermined schedule, when triggered by an internal or external event, or in response to requests from the access network 404. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 4, the hub 414 communicates with the access network 404 to facilitate indirect communication between one or more UEs (e.g., UE 412c and/or 412d) and network nodes (e.g., network node 410b). In some examples, the hub 414 may be a controller, router, a content source and analytics node, or any of the other communication devices described herein regarding UEs. For example, the hub 414 may be a broadband router enabling access to the core network 406 for the UEs. As another example, the hub 414 may be a controller that sends commands or instructions to one or more actuators in the UEs. Commands or instructions may be received from the UEs, network nodes 410, or by executable code, script, process, or other instructions in the hub 414. As another example, the hub 414 may be a data collector that acts as temporary storage for UE data and, in some embodiments, may perform analysis or other processing of the data. As another example, the hub 414 may be a content source. For example, for a UE that is a VR headset, display, loudspeaker or other media delivery device, the hub 414 may retrieve VR assets, video, audio, or other media or data related to sensory information via a network node, which the hub 414 then provides to the UE either directly, after performing local processing, and/or after adding additional local content. In still another example, the hub 414 acts as a proxy server or orchestrator for the UEs, in particular in if one or more of the UEs are low energy IoT devices.

The hub 414 may have a constant/persistent or intermittent connection to the network node 410b. The hub 414 may also allow for a different communication scheme and/or schedule between the hub 414 and UEs (e.g., UE 412c and/or 412d), and between the hub 414 and the core network 406. In other examples, the hub 414 is connected to the core network 406 and/or one or more UEs via a wired connection. Moreover, the hub 414 may be configured to connect to an M2M service provider over the access network 404 and/or to another UE over a direct connection. In some scenarios, UEs may establish a wireless connection with the network nodes 410 while still connected via the hub 414 via a wired or wireless connection. In some embodiments, the hub 414 may be a dedicated hub—that is, a hub whose primary function is to route communications to/from the UEs from/to the network node 410b. In other embodiments, the hub 414 may be a non-dedicated hub—that is, a device which is capable of operating to route communications between the UEs and network node 410b, but which is additionally capable of operating as a communication start and/or end point for certain data channels.

FIG. 5 shows a UE 500 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 500 includes processing circuitry 502 that is operatively coupled via a bus 504 to an input/output interface 506, a power source 508, a memory 510, a communication interface 512, and/or any other component, or any combination thereof. Certain UEs may utilize all or a subset of the components shown in FIG. 5. The level of integration between the components may vary from one UE to another UE. Further, certain UEs may contain multiple instances of a component, such as multiple processors, memories, transceivers, transmitters, receivers, etc.

The processing circuitry 502 is configured to process instructions and data and may be configured to implement any sequential state machine operative to execute instructions stored as machine-readable computer programs in the memory 510. The processing circuitry 502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 502 may include multiple central processing units (CPUs). The processing circuitry 502 may be operable to provide, either alone or in conjunction with other UE 500 components, such as the memory 510, UE 500 functionality. For example, the processing circuitry 502 may be configured to cause the UE 502 to perform the methods as described with reference to FIG. 2

In the example, the input/output interface 506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 508 is structured as a battery or battery pack. Other types of power sources, such as an external power source (e.g., an electricity outlet), photovoltaic device, or power cell, may be used. The power source 508 may further include power circuitry for delivering power from the power source 508 itself, and/or an external power source, to the various parts of the UE 500 via input circuitry or an interface such as an electrical power cable. Delivering power may be, for example, for charging of the power source 508. Power circuitry may perform any formatting, converting, or other modification to the power from the power source 508 to make the power suitable for the respective components of the UE 500 to which power is supplied.

The memory 510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 510 includes one or more application programs 514, such as an operating system, web browser application, a widget, gadget engine, or other application, and corresponding data 516. The memory 510 may store, for use by the UE 500, any of a variety of various operating systems or combinations of operating systems.

The memory 510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 510 may allow the UE 500 to access instructions, application programs and the like, stored on transitory or non-transitory memory media, to off-load data, or to upload data. An article of manufacture, such as one utilizing a communication system may be tangibly embodied as or in the memory 510, which may be or comprise a device-readable storage medium.

The processing circuitry 502 may be configured to communicate with an access network or other network using the communication interface 512. The communication interface 512 may comprise one or more communication subsystems and may include or be communicatively coupled to an antenna 522. The communication interface 512 may include one or more transceivers used to communicate, such as by communicating with one or more remote transceivers of another device capable of wireless communication (e.g., another UE or a network node in an access network). Each transceiver may include a transmitter 518 and/or a receiver 520 appropriate to provide network communications (e.g., optical, electrical, frequency allocations, and so forth). Moreover, the transmitter 518 and receiver 520 may be coupled to one or more antennas (e.g., antenna 522) and may share circuit components, software or firmware, or alternatively be implemented separately.

In some embodiments, communication functions of the communication interface 512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 500 shown in FIG. 5.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 6 shows a network node 600 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 600 includes processing circuitry 602, a memory 604, a communication interface 606, and a power source 608, and/or any other component, or any combination thereof. The network node 600 may be composed of multiple physically separate components (e.g., a NodeB component and a RNC component, or a BTS component and a BSC component, etc.), which may each have their own respective components. In certain scenarios in which the network node 600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 600 may be configured to support multiple radio access technologies (RATs). In such embodiments, some components may be duplicated (e.g., separate memory 604 for different RATs) and some components may be reused (e.g., a same antenna 610 may be shared by different RATs). The network node 600 may also include multiple sets of the various illustrated components for different wireless technologies integrated into network node 600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 600.

The processing circuitry 602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 600 components, such as the memory 604, network node 600 functionality. For example, the processing circuitry 602 may be configured to cause the network node to perform the methods as described with reference to FIG. 3.

In some embodiments, the processing circuitry 602 includes a system on a chip (SOC). In some embodiments, the processing circuitry 602 includes one or more of radio frequency (RF) transceiver circuitry 612 and baseband processing circuitry 614. In some embodiments, the radio frequency (RF) transceiver circuitry 612 and the baseband processing circuitry 614 may be on separate chips (or sets of chips), boards, or units, such as radio units and digital units. In alternative embodiments, part or all of RF transceiver circuitry 612 and baseband processing circuitry 614 may be on the same chip or set of chips, boards, or units.

The memory 604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 602. The memory 604 may store any suitable instructions, data, or information, including a computer program, software, an application including one or more of logic, rules, code, tables, and/or other instructions capable of being executed by the processing circuitry 602 and utilized by the network node 600. The memory 604 may be used to store any calculations made by the processing circuitry 602 and/or any data received via the communication interface 606. In some embodiments, the processing circuitry 602 and memory 604 is integrated.

The communication interface 606 is used in wired or wireless communication of signaling and/or data between a network node, access network, and/or UE. As illustrated, the communication interface 606 comprises port(s)/terminal(s) 616 to send and receive data, for example to and from a network over a wired connection. The communication interface 606 also includes radio front-end circuitry 618 that may be coupled to, or in certain embodiments a part of, the antenna 610. Radio front-end circuitry 618 comprises filters 620 and amplifiers 622. The radio front-end circuitry 618 may be connected to an antenna 610 and processing circuitry 602. The radio front-end circuitry may be configured to condition signals communicated between antenna 610 and processing circuitry 602. The radio front-end circuitry 618 may receive digital data that is to be sent out to other network nodes or UEs via a wireless connection. The radio front-end circuitry 618 may convert the digital data into a radio signal having the appropriate channel and bandwidth parameters using a combination of filters 620 and/or amplifiers 622. The radio signal may then be transmitted via the antenna 610. Similarly, when receiving data, the antenna 610 may collect radio signals which are then converted into digital data by the radio front-end circuitry 618. The digital data may be passed to the processing circuitry 602. In other embodiments, the communication interface may comprise different components and/or different combinations of components.

In certain alternative embodiments, the network node 600 does not include separate radio front-end circuitry 618, instead, the processing circuitry 602 includes radio front-end circuitry and is connected to the antenna 610. Similarly, in some embodiments, all or some of the RF transceiver circuitry 612 is part of the communication interface 606. In still other embodiments, the communication interface 606 includes one or more ports or terminals 616, the radio front-end circuitry 618, and the RF transceiver circuitry 612, as part of a radio unit (not shown), and the communication interface 606 communicates with the baseband processing circuitry 614, which is part of a digital unit (not shown).

The antenna 610 may include one or more antennas, or antenna arrays, configured to send and/or receive wireless signals. The antenna 610 may be coupled to the radio front-end circuitry 618 and may be any type of antenna capable of transmitting and receiving data and/or signals wirelessly. In certain embodiments, the antenna 610 is separate from the network node 600 and connectable to the network node 600 through an interface or port.

The antenna 610, communication interface 606, and/or the processing circuitry 602 may be configured to perform any receiving operations and/or certain obtaining operations described herein as being performed by the network node. Any information, data and/or signals may be received from a UE, another network node and/or any other network equipment. Similarly, the antenna 610, the communication interface 606, and/or the processing circuitry 602 may be configured to perform any transmitting operations described herein as being performed by the network node. Any information, data and/or signals may be transmitted to a UE, another network node and/or any other network equipment.

The power source 608 provides power to the various components of network node 600 in a form suitable for the respective components (e.g., at a voltage and current level needed for each respective component). The power source 608 may further comprise, or be coupled to, power management circuitry to supply the components of the network node 600 with power for performing the functionality described herein. For example, the network node 600 may be connectable to an external power source (e.g., the power grid, an electricity outlet) via an input circuitry or interface such as an electrical cable, whereby the external power source supplies power to power circuitry of the power source 608. As a further example, the power source 608 may comprise a source of power in the form of a battery or battery pack which is connected to, or integrated in, power circuitry. The battery may provide backup power should the external power source fail.

Embodiments of the network node 600 may include additional components beyond those shown in FIG. 6 for providing certain aspects of the network node's functionality, including any of the functionality described herein and/or any functionality necessary to support the subject matter described herein. For example, the network node 600 may include user interface equipment to allow input of information into the network node 600 and to allow output of information from the network node 600. This may allow a user to perform diagnostic, maintenance, repair, and other administrative functions for the network node 600.

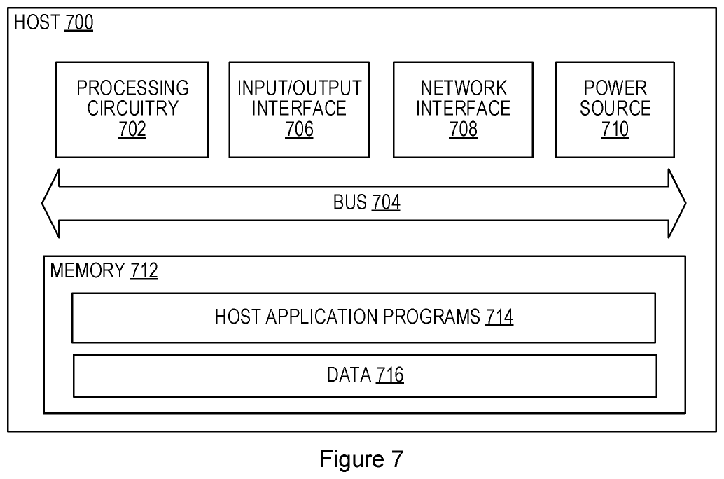

FIG. 7 is a block diagram of a host 700, which may be an embodiment of the host 416 of FIG. 4, in accordance with various aspects described herein. As used herein, the host 700 may be or comprise various combinations hardware and/or software, including a standalone server, a blade server, a cloud-implemented server, a distributed server, a virtual machine, container, or processing resources in a server farm. The host 700 may provide one or more services to one or more UEs.

The host 700 includes processing circuitry 702 that is operatively coupled via a bus 704 to an input/output interface 706, a network interface 708, a power source 710, and a memory 712. Other components may be included in other embodiments. Features of these components may be substantially similar to those described with respect to the devices of previous figures, such as FIGS. 5 and 6, such that the descriptions thereof are generally applicable to the corresponding components of host 700.

The memory 712 may include one or more computer programs including one or more host application programs 714 and data 716, which may include user data, e.g., data generated by a UE for the host 700 or data generated by the host 700 for a UE. Embodiments of the host 700 may utilize only a subset or all of the components shown. The host application programs 714 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 714 may also provide for user authentication and licensing checks and may periodically report health, routes, and content availability to a central node, such as a device in or on the edge of a core network. Accordingly, the host 700 may select and/or indicate a different host for over-the-top services for a UE. The host application programs 714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

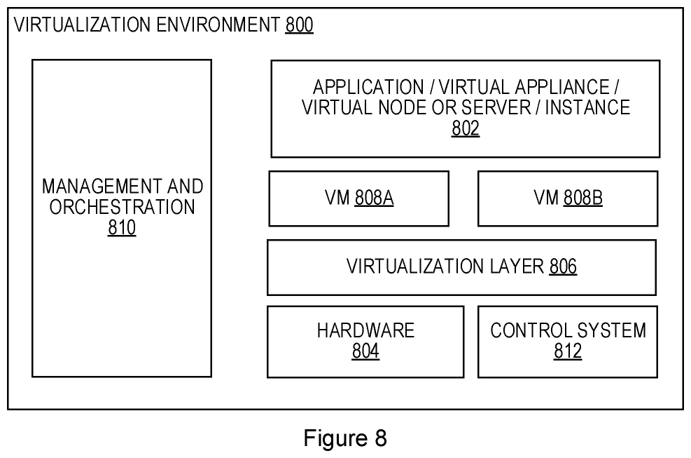

FIG. 8 is a block diagram illustrating a virtualization environment 800 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 802 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 806 (also referred to as hypervisors or virtual machine monitors (VMMs)), provide VMs 808a and 808b (one or more of which may be generally referred to as VMs 808), and/or perform any of the functions, features and/or benefits described in relation with some embodiments described herein. The virtualization layer 806 may present a virtual operating platform that appears like networking hardware to the VMs 808.

The VMs 808 comprise virtual processing, virtual memory, virtual networking or interface and virtual storage, and may be run by a corresponding virtualization layer 806. Different embodiments of the instance of a virtual appliance 802 may be implemented on one or more of VMs 808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 808 may be a software implementation of a physical machine that runs programs as if they were executing on a physical, non-virtualized machine. Each of the VMs 808, and that part of hardware 804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 808 on top of the hardware 804 and corresponds to the application 802.

Hardware 804 may be implemented in a standalone network node with generic or specific components. Hardware 804 may implement some functions via virtualization. Alternatively, hardware 804 may be part of a larger cluster of hardware (e.g. such as in a data center or CPE) where many hardware nodes work together and are managed via management and orchestration 810, which, among others, oversees lifecycle management of applications 802. In some embodiments, hardware 804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 812 which may alternatively be used for communication between hardware nodes and radio units.

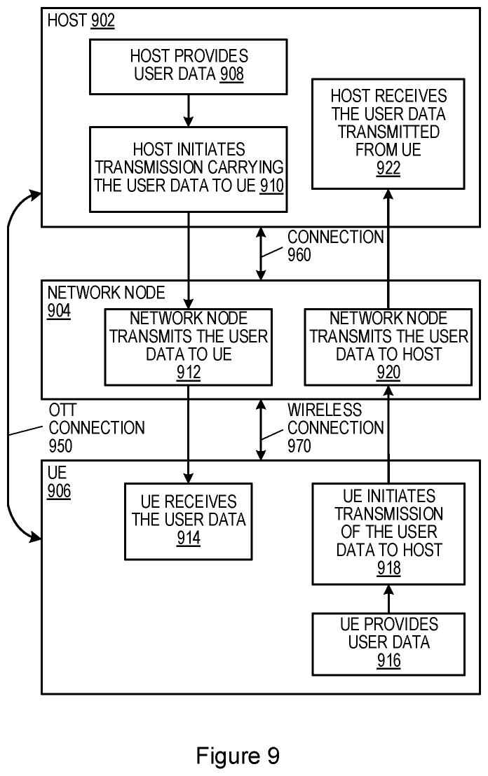

FIG. 9 shows a communication diagram of a host 902 communicating via a network node 904 with a UE 906 over a partially wireless connection in accordance with some embodiments. Example implementations, in accordance with various embodiments, of the UE (such as a UE 412a of FIG. 4 and/or UE 500 of FIG. 5), network node (such as network node 410a of FIG. 4 and/or network node 600 of FIG. 6), and host (such as host 416 of FIG. 4 and/or host 700 of FIG. 7) discussed in the preceding paragraphs will now be described with reference to FIG. 9.

Like host 700, embodiments of host 902 include hardware, such as a communication interface, processing circuitry, and memory. The host 902 also includes software, which is stored in or accessible by the host 902 and executable by the processing circuitry. The software includes a host application that may be operable to provide a service to a remote user, such as the UE 906 connecting via an over-the-top (OTT) connection 950 extending between the UE 906 and host 902. In providing the service to the remote user, a host application may provide user data which is transmitted using the OTT connection 950.

The network node 904 includes hardware enabling it to communicate with the host 902 and UE 906. The connection 960 may be direct or pass through a core network (like core network 406 of FIG. 4) and/or one or more other intermediate networks, such as one or more public, private, or hosted networks. For example, an intermediate network may be a backbone network or the Internet.

The UE 906 includes hardware and software, which is stored in or accessible by UE 906 and executable by the UE's processing circuitry. The software includes a client application, such as a web browser or operator-specific “app” that may be operable to provide a service to a human or non-human user via UE 906 with the support of the host 902. In the host 902, an executing host application may communicate with the executing client application via the OTT connection 950 terminating at the UE 906 and host 902. In providing the service to the user, the UE's client application may receive request data from the host's host application and provide user data in response to the request data. The OTT connection 950 may transfer both the request data and the user data. The UE's client application may interact with the user to generate the user data that it provides to the host application through the OTT connection 950.

The OTT connection 950 may extend via a connection 960 between the host 902 and the network node 904 and via a wireless connection 970 between the network node 904 and the UE 906 to provide the connection between the host 902 and the UE 906. The connection 960 and wireless connection 970, over which the OTT connection 950 may be provided, have been drawn abstractly to illustrate the communication between the host 902 and the UE 906 via the network node 904, without explicit reference to any intermediary devices and the precise routing of messages via these devices.

As an example of transmitting data via the OTT connection 950, in step 908, the host 902 provides user data, which may be performed by executing a host application. In some embodiments, the user data is associated with a particular human user interacting with the UE 906. In other embodiments, the user data is associated with a UE 906 that shares data with the host 902 without explicit human interaction. In step 910, the host 902 initiates a transmission carrying the user data towards the UE 906. The host 902 may initiate the transmission responsive to a request transmitted by the UE 906. The request may be caused by human interaction with the UE 906 or by operation of the client application executing on the UE 906. The transmission may pass via the network node 904, in accordance with the teachings of the embodiments described throughout this disclosure. Accordingly, in step 912, the network node 904 transmits to the UE 906 the user data that was carried in the transmission that the host 902 initiated, in accordance with the teachings of the embodiments described throughout this disclosure. In step 914, the UE 906 receives the user data carried in the transmission, which may be performed by a client application executed on the UE 906 associated with the host application executed by the host 902.

In some examples, the UE 906 executes a client application which provides user data to the host 902. The user data may be provided in reaction or response to the data received from the host 902. Accordingly, in step 916, the UE 906 may provide user data, which may be performed by executing the client application. In providing the user data, the client application may further consider user input received from the user via an input/output interface of the UE 906. Regardless of the specific manner in which the user data was provided, the UE 906 initiates, in step 918, transmission of the user data towards the host 902 via the network node 904. In step 920, in accordance with the teachings of the embodiments described throughout this disclosure, the network node 904 receives user data from the UE 906 and initiates transmission of the received user data towards the host 902. In step 922, the host 902 receives the user data carried in the transmission initiated by the UE 906.

One or more of the various embodiments improve the performance of OTT services provided to the UE 906 using the OTT connection 950, in which the wireless connection 970 forms the last segment. More precisely, the teachings of these embodiments may improve the power consumption of the UE and thereby provide benefits such as extended battery lifetime.

In an example scenario, factory status information may be collected and analyzed by the host 902. As another example, the host 902 may process audio and video data which may have been retrieved from a UE for use in creating maps. As another example, the host 902 may collect and analyze real-time data to assist in controlling vehicle congestion (e.g., controlling traffic lights). As another example, the host 902 may store surveillance video uploaded by a UE. As another example, the host 902 may store or control access to media content such as video, audio, VR or AR which it can broadcast, multicast or unicast to UEs. As other examples, the host 902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 950 between the host 902 and UE 906, in response to variations in the measurement results. The measurement procedure and/or the network functionality for reconfiguring the OTT connection may be implemented in software and hardware of the host 902 and/or UE 906. In some embodiments, sensors (not shown) may be deployed in or in association with other devices through which the OTT connection 950 passes; the sensors may participate in the measurement procedure by supplying values of the monitored quantities exemplified above, or supplying values of other physical quantities from which software may compute or estimate the monitored quantities. The reconfiguring of the OTT connection 950 may include message format, retransmission settings, preferred routing etc.; the reconfiguring need not directly alter the operation of the network node 904. Such procedures and functionalities may be known and practiced in the art. In certain embodiments, measurements may involve proprietary UE signaling that facilitates measurements of throughput, propagation times, latency and the like, by the host 902. The measurements may be implemented in that software causes messages to be transmitted, in particular empty or ‘dummy’ messages, using the OTT connection 950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EMBODIMENTS

### Group A Embodiments

1. A method performed by a user equipment for reporting Quality of Experience measurements for a Multicast Broadcast Service, MBS, the method comprising:
   receiving, from a network node, a configuration configuring reporting of QoE measurements of the MBS, wherein the configuration indicates that QoE measurements are to be performed or QoE reports are to be reported upon fulfilment of one or more conditions.
2. The method of embodiment 1 wherein the QoE measurements comprise Radio Access Network, RAN, visible QoE, RvQoE, measurements.
3. The method of any previous embodiment wherein the one or more conditions comprises: a condition that a particular type of service is being transmitted using the MBS.
4. The method of any previous embodiment wherein the one or more conditions comprises a condition that the user equipment has an ability to use certain features for sending QoE reports.
5. The method of any previous embodiment wherein the one or more conditions comprises a condition that the user equipment is in a certain radio resource control, RRC, state or that the user equipment transfers to or from a certain RRC state.
6. The method of any previous embodiment wherein the one or more conditions comprises a condition that the QoE measurements are executed and/or one or more QoE reports are transmitted when an application session starts whilst the user equipment is in a certain radio resource control, RRC, state.
7. The method of any previous embodiment wherein the one or more conditions comprises a condition that QoE measurements are executed and/or one or more QoE reports are transmitted when the user equipment is in a certain RRC state.
8. The method of any previous embodiment wherein the one or more conditions comprises a condition that QoE measurements are executed and/or QoE reports are transmitted upon, during or after a transition to/from a specific radio resource control, RRC state, or upon, during or after any transition between RRC states.
9. The method of any previous embodiment wherein the one or more conditions comprises a condition that a specific MBS delivery mode is used.
10. The method of any previous embodiment wherein the one or more conditions comprises a condition that the user equipment joined or is joining a Multicast session.
11. The method of any previous embodiment wherein the configuration indicates that QoE measurements are to be stopped upon sending an indication that the user equipment left or is leaving a Multicast session.
12. The method of any previous embodiment wherein the configuration indicates to start or resume transmitting one or more QoE reports upon sending an indication that the UE has left a Multicast session.
13. The method of any previous embodiment wherein the configuration indicates to start or resume transmitting one or more QoE reports upon receiving a certain packet within a Multicast session or a Broadcast session.
14. The method of any previous embodiment wherein the one or more conditions comprises a condition that a switch between Broadcast, Multicast, and/or Unicast traffic delivery modes for an ongoing MBS session has occurred or is occurring.
15. The method of any previous embodiment wherein the one or more conditions comprises a condition that a certain frequency starts, or stops being used for an MBS session.
16. The method of any previous embodiment wherein the one or more conditions comprises a condition that, either point-to-point, PTP, point-to-multipoint PTM, or either PTP and/or PTM is used for data delivery.
17. The method of any previous embodiment wherein the one or more conditions comprises a condition that a switch in data delivery modes for an MBS session occurs or is occurring.
18. The method of any previous embodiment wherein the one or more conditions comprises a condition that a threshold number of switches in data delivery modes is exceeded or reached.
19. The method of any previous embodiment wherein the one or more conditions comprises a condition that a threshold for one or more QoE or Radio Access Network, RAN, visible QoE, RVQoE, metrics or RVQoE values for the MBS is reached or exceed.
20. The method of any previous embodiment wherein the one or more conditions comprises a condition that a switch from a MBS radio bearer, MRB, to a data radio bearer DRB occurs.
21. The method of any previous embodiment wherein the one or more conditions comprises a condition that a certain number of packets or amount of data has been received using point-to-point, PTP, and/or point-to-multipoint, PTM, or less than a certain number of packets or amount of data has been received using PTP and/or PTM.
22. The method of any previous embodiment wherein the one or more conditions comprises a condition that a switch between Multicast, Unicast and/or Broadcast for an MBS session occurs.
23. The method of any previous embodiment wherein the one or more conditions comprises a condition that a certain number of packets or amount of data is received using an MBS radio bearer, MRB, and/or a data radio bearer, DRB, or less than a certain number of packets or amount of data is received using an MRB and/or a DRB.
24. The method of any previous embodiment wherein the one or more conditions comprises a condition that, when Hybrid Automatic Repeat Request, HARQ, retransmissions are used, one of:
   a certain number of retransmissions are executed have been executed; and
   an average number of retransmissions reaches or exceeds a certain threshold.
25. The method of any previous embodiment wherein the one or more conditions comprises a condition that a certain number of proactive/blind retransmissions have been executed during the broadcast MBS session
26. The method of any previous embodiment wherein the one or more conditions comprises a condition that, when in an MBS broadcast mode, one of:
   at least a threshold number of blind/proactive retransmissions were needed for correct reception/decoding in the user equipment; and
   an average number of blind/proactive retransmissions needed for correct reception/decoding in the user equipment reaches or exceeds a threshold.
27. The method of any previous embodiment wherein the one or more conditions comprises a condition that either a threshold a number of packets the user equipment failed to receive is reached/exceeded or is not reached/exceeded.
28. The method of any previous embodiment wherein the one or more conditions comprises a condition that a certain packet loss rate is reached/exceeded or is not reached/exceeded.
29. The method of any previous embodiment wherein the one or more conditions comprises a condition that 5GC Shared MBS traffic delivery or 5GC Individual MBS traffic delivery, or both, start or stop being used.
30. The method of any previous embodiment wherein the one or more conditions comprises a condition that traffic delivery changes between 5GC Shared MBS and 5GC Individual.
31. The method of any previous embodiment wherein the one or more conditions comprises a condition that a handover occurs.
32. The method of any previous embodiment wherein the one or more conditions comprises a condition that the user equipment selects a cell of a network node supporting MBS.
33. The method of any previous embodiment wherein the one or more conditions comprises a condition that the user equipment re-selects to a cell of a network node supporting MBS.
34. The method of any previous embodiment wherein the one or more conditions comprises a condition that the user equipment initiates a broadcast MBS radio bearer, MRB, establishment or a broadcast MRB release procedure to start or stop receiving an MBS session of a MBS broadcast service of interest, respectively.
35. The method of any previous embodiment wherein the one or more conditions comprises a condition that the user equipment joins or leaves a Multicast MBS session.
36. The method of any previous embodiment wherein the one or more conditions comprises a condition that the user equipment uses or is configured in multi-radio dual connectivity 37. The method of any previous embodiment wherein the one or more conditions comprises a condition that an RRC setup procedure is triggered for the user equipment.
38. The method of any previous embodiment wherein the one or more conditions comprises a condition that an RRC re-establishment occurs.
39. The method of any previous embodiment wherein the one or more conditions comprises a condition that a radio quality of the user equipment is below or above a certain threshold.
40. The method of any previous embodiment wherein the one or more conditions comprises a condition that a buffer level in the user equipment is below or above a certain threshold.
41. The method of any previous embodiment wherein the one or more conditions comprises a condition that a number of buffer level entries in the user equipment exceeds a certain threshold number of entries.
42. The method of any of the previous embodiments, further comprising:
   providing user data; and
   forwarding the user data to a host via the transmission to the network node.

### Group B Embodiments

43. A method performed by a network node for configuring reporting Quality of Experience measurements for a Multicast Broadcast Service, MBS, the method comprising:
   transmitting, to a user equipment, a configuration configuring reporting of QoE measurements of the MBS, wherein the configuration indicates that QoE measurements are to be performed or QoE reports are to be reported upon fulfilment of one or more conditions.
44. The method of embodiment 43 wherein the QoE measurements comprise Radio Access Network, RAN, visible QoE, RvQoE, measurements.
45. The method of any one of embodiments 43 to 44 wherein the one or more conditions comprises: a condition that a particular type of service is being transmitted using the MBS.
46. The method of any one of embodiments 43 to 45 wherein the one or more conditions comprises a condition that the user equipment has an ability to use certain features for sending QoE reports.
47. The method of any one of embodiments 43 to 46 wherein the one or more conditions comprises a condition that the user equipment is in a certain radio resource control, RRC, state or that the user equipment transfers to or from a certain RRC state.
48. The method of any one of embodiments 43 to 47 wherein the one or more conditions comprises a condition that the QoE measurements are executed and/or one or more QoE reports are transmitted when an application session starts whilst the user equipment is in a certain radio resource control, RRC, state.
49. The method of any one of embodiments 43 to 48 wherein the one or more conditions comprises a condition that QoE measurements are executed and/or one or more QoE reports are transmitted when the user equipment is in a certain RRC state.
50. The method of any one of embodiments 43 to 49 wherein the one or more conditions comprises a condition that QoE measurements are executed and/or QoE reports are transmitted upon, during or after a transition to/from a specific radio resource control, RRC state, or upon, during or after any transition between any RRC states.
51. The method of any one of embodiments 43 to 50 wherein the one or more conditions comprises a condition that a specific MBS delivery mode is used.
52. The method of any one of embodiments 43 to 51 wherein the one or more conditions comprises a condition that the user equipment joined or is joining a Multicast session.
53. The method of any one of embodiments 43 to 52 wherein the configuration indicates that QoE measurements are to be stopped upon sending an indication that the user equipment left or is leaving a Multicast session.
54. The method of any one of embodiments 43 to 53 wherein the configuration indicates to start or resume transmitting one or more QoE reports upon sending an indication that the UE has left a Multicast session.
55. The method of any one of embodiments 43 to 54 wherein the configuration indicates to start or resume transmitting one or more QoE reports upon transmitting a certain packet within a Multicast session or a Broadcast session.
56. The method of any one of embodiments 43 to 55 wherein the one or more conditions comprises a condition that a switch between Broadcast, Multicast, and/or Unicast traffic delivery modes for an ongoing MBS session has occurred or is occurring.
57. The method of any one of embodiments 43 to 56 wherein the one or more conditions comprises a condition that a certain frequency starts, or stops being used for an MBS session.
58. The method of any one of embodiments 43 to 57 wherein the one or more conditions comprises a condition that, either point-to-point, PTP, point-to-multipoint PTM, or either PTP and/or PTM is used for data delivery.
59. The method of any one of embodiments 43 to 58 wherein the one or more conditions comprises a condition that a switch in data delivery modes for an MBS session occurs or is occurring.
60. The method of any one of embodiments 43 to 59 wherein the one or more conditions comprises a condition that a threshold number of switches in data delivery modes is exceeded or reached.
61. The method of any one of embodiments 43 to 60 wherein the one or more conditions comprises a condition that a threshold for one or more QoE or RVQoE metrics for the MBS is reached or exceed.
62. The method of any one of embodiments 43 to 61 wherein the one or more conditions comprises a condition that a switch from a MBS radio bearer, MRB, to a data radio bearer DRB occurs.
63. The method of any one of embodiments 43 to 62 wherein the one or more conditions comprises a condition that a certain number of packets or amount of data has been sent or delivered using point-to-point, PTP, and/or point-to-multipoint, PTM, or less than a certain number of packets or amount of data has been sent or delivered using PTP and/or PTM.
64. The method of any one of embodiments 43 to 63 wherein the one or more conditions comprises a condition that a switch between Multicast, Unicast and/or Broadcast for an MBS session occurs.
65. The method of any one of embodiments 43 to 64 wherein the one or more conditions comprises a condition that a certain number of packets or amount of data is sent or delivered using an MBS radio bearer, MRB, and/or a data radio bearer, DRB, or less than a certain number of packets or amount of data is sent or delivered using an MRB and/or a DRB.
66. The method of any one of embodiments 43 to 65 wherein the one or more conditions comprises a condition that, when Hybrid Automatic Repeat Request, HARQ, retransmissions are used, one of:
   a certain number of retransmissions are executed have been executed; and
   an average number of retransmissions reaches or exceeds a certain threshold.
67. The method of any one of embodiments 43 to 66 wherein the one or more conditions comprises a condition that a certain number of proactive/blind retransmissions have been executed during the broadcast MBS session
68. The method of any one of embodiments 43 to 67 wherein the one or more conditions comprises a condition that, when in an MBS broadcast mode, one of:
   at least a threshold number of blind/proactive retransmissions were needed for correct reception/decoding in the user equipment; and
   an average number of blind/proactive retransmissions needed for correct reception/decoding in the user equipment reaches or exceeds a threshold.
69. The method of any one of embodiments 43 to 68 wherein the one or more conditions comprises a condition that either a threshold a number of packets the user equipment failed to receive is reached/exceeded or is not reached/exceeded.
70. The method of any one of embodiments 43 to 69 wherein the one or more conditions comprises a condition that a certain packet loss rate is reached/exceeded or is not reached/exceeded.
71. The method of any one of embodiments 43 to 70 wherein the one or more conditions comprises a condition that 5GC Shared MBS traffic delivery or 5GC Individual MBS traffic delivery, or both, start or stop being used.
72. The method of any one of embodiments 43 to 71 wherein the one or more conditions comprises a condition that traffic delivery changes between 5GC Shared MBS and 5GC Individual.
73. The method of any one of embodiments 43 to 72 wherein the one or more conditions comprises a condition that a handover occurs.
74. The method of any one of embodiments 43 to 73 wherein the one or more conditions comprises a condition that the user equipment selects a cell of a network node supporting MBS.
75. The method of any one of embodiments 43 to 74 wherein the one or more conditions comprises a condition that the user equipment re-selects to a cell of a network node supporting MBS.
76. The method of any one of embodiments 43 to 75 wherein the one or more conditions comprises a condition that the user equipment initiates a broadcast MBS radio bearer, MRB, establishment or a broadcast MRB release procedure to start or stop receiving an MBS session of a MBS broadcast service of interest, respectively.
77. The method of any one of embodiments 43 to 76 wherein the one or more conditions comprises a condition that the user equipment joins or leaves a Multicast MBS session.
78. The method of any one of embodiments 43 to 77 wherein the one or more conditions comprises a condition that the user equipment uses or is configured in multi-radio dual connectivity
79. The method of any one of embodiments 43 to 78 wherein the one or more conditions comprises a condition that an RRC setup procedure is triggered for the user equipment.
80. The method of any one of embodiments 43 to 79 wherein the one or more conditions comprises a condition that an RRC re-establishment occurs.
81. The method of any one of embodiments 43 to 80 wherein the one or more conditions comprises a condition that a radio quality of the user equipment is below or above a certain threshold.
82. The method of any one of embodiments 43 to 81 wherein the one or more conditions comprises a condition that a buffer level in the user equipment is below or above a certain threshold.
83. The method of any one of embodiments 43 to 82 wherein the one or more conditions comprises a condition that a number of buffer level entries in the user equipment exceeds a certain threshold number of entries.
84. The method of any one of embodiments 43 to 83, further comprising:
   obtaining user data; and
   forwarding the user data to a host or a user equipment.

### Group C Embodiments

85. A user equipment for reporting Quality of Experience measurements for a Multicast Broadcast Service, MBS, comprising:
   processing circuitry configured to cause the user equipment to perform any of the steps of any of the Group A embodiments; and
   power supply circuitry configured to supply power to the processing circuitry.
86. A network node for configuring for reporting Quality of Experience measurements for a Multicast Broadcast Service, MBS, the network node comprising:
   processing circuitry configured to cause the network node to perform any of the steps of any of the Group B embodiments;
   power supply circuitry configured to supply power to the processing circuitry.
87. A user equipment (UE) for reporting Quality of Experience measurements for a Multicast Broadcast Service, MBS, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
88. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to receive the user data from the host.
89. The host of the previous embodiment, wherein the cellular network further includes a network node configured to communicate with the UE to transmit the user data to the UE from the host.
90. The host of the previous 2 embodiments, wherein:
   the processing circuitry of the host is configured to execute a host application, thereby providing the user data; and
   the host application is configured to interact with a client application executing on the UE, the client application being associated with the host application.
91. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any of the Group A embodiments to receive the user data from the host.
92. The method of the previous embodiment, further comprising:
   at the host, executing a host application associated with a client application executing on the UE to receive the user data from the UE.
93. The method of the previous embodiment, further comprising:
   at the host, transmitting input data to the client application executing on the UE, the input data being provided by executing the host application,
   wherein the user data is provided by the client application in response to the input data from the host application.
94. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to transmit the user data to the host.
95. The host of the previous embodiment, wherein the cellular network further includes a network node configured to communicate with the UE to transmit the user data from the UE to the host.
96. The host of the previous 2 embodiments, wherein:
   the processing circuitry of the host is configured to execute a host application, thereby providing the user data; and
   the host application is configured to interact with a client application executing on the UE, the client application being associated with the host application.
97. A method implemented by a host configured to operate in a communication system that further includes a network node and a user equipment (UE), the method comprising:
   at the host, receiving user data transmitted to the host via the network node by the UE, wherein the UE performs any of the steps of any of the Group A embodiments to transmit the user data to the host.
98. The method of the previous embodiment, further comprising:
   at the host, executing a host application associated with a client application executing on the UE to receive the user data from the UE.
99. The method of the previous embodiment, further comprising:
   at the host, transmitting input data to the client application executing on the UE, the input data being provided by executing the host application,
   wherein the user data is provided by the client application in response to the input data from the host application.
100. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
101. The host of the previous embodiment, wherein:
   the processing circuitry of the host is configured to execute a host application that provides the user data; and
   the UE comprises processing circuitry configured to execute a client application associated with the host application to receive the transmission of user data from the host.
102. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of the Group B embodiments to transmit the user data from the host to the UE.
103. The method of the previous embodiment, further comprising, at the network node, transmitting the user data provided by the host for the UE.
104. The method of any of the previous 2 embodiments, wherein the user data is provided at the host by executing a host application that interacts with a client application executing on the UE, the client application being associated with the host application.
105. A communication system configured to provide an over-the-top service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
106. The communication system of the previous embodiment, further comprising:
   the network node; and/or
   the user equipment.
107. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
108. The host of the previous embodiment, wherein:
   the processing circuitry of the host is configured to execute a host application, thereby providing the user data; and
   the host application is configured to interact with a client application executing on the UE, the client application being associated with the host application.
109. The host of the any of the previous 2 embodiments, wherein the initiating receipt of the user data comprises requesting the user data.
110. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of the Group B embodiments to receive the user data from the UE for the host.
111. The method of the previous embodiment, further comprising at the network node, transmitting the received user data to the host.

### Abbreviations

At least some of the following abbreviations may be used in this disclosure. If there is an inconsistency between abbreviations, preference should be given to how it is used above. If listed multiple times below, the first listing should be preferred over any subsequent listing(s).
3GPP 3rd Generation Partnership Project
5G 5th Generation
5GC 5G Core
5GS 5th Generation System
AMF Access and Mobility Management Function
AR Augmented Reality
AS Access Stratum
ASN.1 Abstract Syntax Notation One
AT Attention
BWP Bandwidth Part
CGI Cell Global Identity
CHO Conditional Handover
CN Core Network
CP Control Plane
C-RNTI Cell RNTI
CU Central Unit
DASH Dynamic Adaptive Streaming over HTTP
DC Dual Connectivity
DCI Downlink Control Information
DL Downlink
DRB Data Radio Bearer
DU Distributed Unit
EPC Evolved Packet Core
EPS Evolved Packet System
FDD Frequency Division Duplex
gNB Radio base station in NR
HARQ Hybrid Automatic Repeat reQuest
HSS Home Subscriber Server
HTTP Hypertext Transfer Protocol
IAB Integrated Access and Backhaul
ID Identifier/Identity
IE Information Element
IMS IP Multimedia Subsystem
IP Internet Protocol
LAI Location Area Identifier
LTE Long Term Evolution
MAC Medium Access Control
MBMS Multimedia Broadcast Multicast Service
MBS Multicast Broadcast Service
MCC Mobile Country Code
MCE Measurement Collector Entity
MDT Minimization of Drive Tests
MME Mobility Management Entity
MNC Mobile Network Code
MTSI Multimedia Telephony Service for IMS
NG Next Generation/The interface between NG-RAN and 5GC.
NGAP NG Application Protocol
NG-RAN NG Radio Access Network
NR New Radio
O&M Operation and Maintenance
OAM Operation and Maintenance
PDCP Packet Data Convergence Protocol
PLMN Public Land Mobile Network
PSCell Primary Secondary Cell
PTP Point-to-point
PTM Point-to-multipoint
QMC QoE Measurement Collection
QOE Quality of Experience
RAI Routing Area Identifier
RAN Radio Access Network
RAT Radio Access Technology
RB Radio Bearer
RLC Radio Link Control
RLF Radio Link Failure
RNC Radio Network Controller
RNTI Radio Network Temporary Identity
RRC Radio Resource Control
RVQOE RAN Visible QoE
SCell Secondary Cell
SN Secondary Node
SN Sequence Number
SRB Signaling Radio Bearer
TAC Tracking Area Code
TAI Tracking Area Identifier
TCE Trace Collector Entity
TDD Time Division Duplex
TS Technical Specification
UDM Unified Data Management
UE User Equipment
UMTS Universal Mobile Telecommunication System
UP User Plane
UPF User Plane Function
VR Virtual Reality
Xn The interface between two gNBs in NR.
XnAP Xn Application Protocol
1×RTT CDMA2000 1× Radio Transmission Technology
3GPP 3rd Generation Partnership Project
5G 5th Generation
6G 6th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
eMBMS evolved Multimedia Broadcast Multicast Services
E-SMLC Evolved-Serving Mobile Location Centre
ECGI Evolved CGI
eNB E-UTRAN NodeB
ePDCCH Enhanced Physical Downlink Control Channel
E-SMLC Evolved Serving Mobile Location Center
E-UTRA Evolved UTRA
E-UTRAN Evolved UTRAN
FDD Frequency Division Duplex
FFS For Further Study
gNB Base station in NR
GNSS Global Navigation Satellite System
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MAC Message Authentication Code
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
USIM Universal Subscriber Identity Module
UTDOA Uplink Time Difference of Arrival
WCDMA Wide CDMA
WLAN Wide Local Area Network

### REFERENCES

RP-221803, “WID update for Enhancement on NR QoE”, 3GPP
3GPP TS 23.247, v17.3.0
3GPP TS 26.346, v17.1.0
3GPP TS 38.300, v17.1.0
3GPP TS 38.331 v17.1.0
TR 38.890, v17.0.0

1-24. (canceled)

25. A method performed by a user equipment for reporting Quality of Experience (QoE) measurements for a Multicast Broadcast Service (MBS), the method comprising:
receiving, from a network node, a configuration configuring the performing and/or reporting of QoE measurements of the MBS, wherein the configuration indicates that QoE measurements are to be performed and/or QoE reports are to be reported upon fulfilment of one or more conditions.

26. The method of claim 25, wherein the QoE measurements comprise Radio Access Network (RAN)-visible QoE (RVQoE) measurements.

27. The method of claim 25, wherein the one or more conditions comprises one or more of:
a particular service type is being transmitted using the MBS;
the user equipment has an ability to use certain features for sending QoE reports;
the user equipment is in a certain radio resource control (RRC) state or that the user equipment transfers to or from a certain RRC state.

28. The method of claim 25, wherein the one or more conditions comprises a condition that the QoE measurements are executed and/or one or more QoE reports are transmitted one of:
when an application session starts whilst the user equipment is in a certain RRC state;
when the user equipment is in a certain RRC state; or
upon, during or after a transition to/from a specific RRC state, or upon, during or after any transition between RRC states.

29. The method of claim 25, wherein the one or more conditions comprises a condition that one or more of:
a specific MBS delivery mode is used; and
the user equipment joined or is joining a Multicast session.

30. The method of claim 25, wherein the configuration indicates one or more of:
that QoE measurements are to be stopped upon sending an indication that the user equipment left or is leaving a Multicast session;
to start or resume transmitting one or more QoE reports upon sending an indication that the UE has left a Multicast session; and
to start or resume transmitting one or more QoE reports upon receiving a certain packet within a Multicast session or a Broadcast session.

31. The method of claim 25, wherein the one or more conditions comprises a condition that a switch between Broadcast, Multicast, and/or Unicast for an ongoing MBS session has occurred or is occurring.

32. The method of claim 25, wherein the one or more conditions comprises a condition that one or more of:
a certain frequency starts, or stops being used for an MBS session;
a threshold number of switches in data delivery modes is exceeded or reached;
a threshold for one or more QoE or Radio Access Network (RAN)-visible QoE (RVQoE) metrics or RVQoE values for the MBS is reached or exceed;
a switch between a MBS radio bearer (MRB) and a data radio bearer (DRB) occurs;
a switch between Multicast, Unicast and/or Broadcast for an MBS session occurs;
a certain number of packets or amount of data is received using an MRB and/or a DRB, or less than a certain number of packets or amount of data is received using an MRB and/or a DRB;
either a threshold a number of packets the user equipment failed to receive is reached/exceeded or is not reached/exceeded;
a certain packet loss rate is reached/exceeded or is not reached/exceeded;
5GC Shared MBS traffic delivery or 5GC Individual MBS traffic delivery, or both, start or stop being used;
traffic delivery changes between 5GC Shared MBS and 5GC Individual;
a handover occurs;
the user equipment selects a cell of a network node supporting MBS;
the user equipment selects a cell of a network node not supporting MBS;
the user equipment re-selects to a cell of a network node supporting MBS;
the user equipment re-selects to a cell of a network node not supporting MBS;
the user equipment initiates a broadcast MBS radio bearer, MRB, establishment or a broadcast MRB release procedure to start or stop receiving an MBS session of a MBS broadcast service of interest, respectively;
the user equipment joins or leaves a Multicast MBS session;
the user equipment uses or is configured in multi-radio dual connectivity;
an RRC setup procedure is triggered for the user equipment;
an RRC re-establishment occurs;
a radio quality of the user equipment is below or above a certain threshold;
a buffer level in the user equipment is below or above a certain threshold; and
a number of buffer level entries in the user equipment exceeds a certain threshold number of entries.

33. A method performed by a network node for configuring the performing and/or the reporting of Quality of Experience (QoE) measurements for a Multicast Broadcast Service (MBS), the method comprising:
transmitting, to a user equipment, a configuration configuring the performing and/or reporting of QoE measurements of the MBS, wherein the configuration indicates that QoE measurements are to be performed and/or QoE reports are to be reported upon fulfilment of one or more conditions.

34. The method of claim 33, wherein the QoE measurements comprise Radio Access Network (RAN)-visible QoE (RVQoE) measurements.

35. The method of claim 33, wherein the one or more conditions comprises a condition that one or more of:
a particular service type is being transmitted using the MBS; the user equipment has an ability to use certain features for sending QoE reports; and
the user equipment is in a certain radio resource control (RRC) state or that the user equipment transfers to or from a certain RRC state.

36. The method of claim 33, wherein the one or more conditions comprises a condition that the QoE measurements are executed and/or one or more QoE reports are transmitted one of:
when an application session starts whilst the user equipment is in a certain RRC state;
when the user equipment is in a certain RRC state; and
upon, during or after a transition to/from a specific RRC state or upon, during or after any transition between any RRC states.

37. The method of claim 33, wherein the one or more conditions comprises a condition that one or more of: a specific MBS delivery mode is used; and the user equipment joined or is joining a Multicast session.

38. The method of claim 33, wherein the configuration indicates one or more of:
that QoE measurements are to be stopped upon sending an indication that the user equipment left or is leaving a Multicast session;
to start or resume transmitting one or more QoE reports upon sending an indication that the UE has left a Multicast session;
to start or resume transmitting one or more QoE reports upon transmitting a certain packet within a Multicast session or a Broadcast session.

39. The method of claim 33, wherein the one or more conditions comprises a condition that a switch between Broadcast, Multicast, and/or Unicast traffic delivery modes for an ongoing MBS session has occurred or is occurring.

40. The method of claim 33, wherein the one or more conditions comprises a condition that one or more of:
a certain frequency starts, or stops being used for an MBS session;
a threshold number of switches in data delivery modes is exceeded or reached;
a threshold for one or more QoE or RVQoE metrics for the MBS is reached or exceed;
a switch between a MBS radio bearer (MRB) and a data radio bearer (DRB) occurs;
a switch between Multicast, Unicast and/or Broadcast for an MBS session occurs;
a certain number of packets or amount of data is sent or delivered using an MRB and/or a DRB, or less than a certain number of packets or amount of data is sent or delivered using an MRB and/or a DRB;
either a threshold a number of packets the user equipment failed to receive is reached/exceeded or is not reached/exceeded;
a certain packet loss rate is reached/exceeded or is not reached/exceeded;
5GC Shared MBS traffic delivery or 5GC Individual MBS traffic delivery, or both, start or stop being used;
traffic delivery changes between 5GC Shared MBS and 5GC Individual;
a handover occurs;
the user equipment selects a cell of a network node supporting MBS;
the user equipment selects a cell of a network node not supporting MBS;
the user equipment re-selects to a cell of a network node supporting MBS;
the user equipment re-selects to a cell of a network node not supporting MBS;
the user equipment initiates a broadcast MBS radio bearer, MRB, establishment or a broadcast MRB release procedure to start or stop receiving an MBS session of a MBS broadcast service of interest, respectively;
the user equipment joins or leaves a Multicast MBS session;
the user equipment uses or is configured in multi-radio dual connectivity;
an RRC setup procedure is triggered for the user equipment;
an RRC re-establishment occurs;
a radio quality of the user equipment is below or above a certain threshold;
a buffer level in the user equipment is below or above a certain threshold;
a number of buffer level entries in the user equipment exceeds a certain threshold number of entries.

41. A user equipment for reporting Quality of Experience (QoE) measurements for a Multicast Broadcast Service (MBS), comprising:
processing circuitry configured to cause the user equipment to receive, from a network node, a configuration configuring the performing and/or reporting of QoE measurements of the MBS, wherein the configuration indicates that QoE measurements are to be performed and/or QoE reports are to be reported upon fulfilment of one or more conditions.

42. The user equipment of claim 41, wherein the one or more conditions comprise one or more of:
a particular service type is being transmitted using the MBS;
the user equipment has an ability to use certain features for sending QoE reports;
the user equipment is in a certain radio resource control (RRC) state or that the user equipment transfers to or from a certain RRC state.

43. A network node for configuring for reporting Quality of Experience (QoE) measurements for a Multicast Broadcast Service (MBS), the network node comprising:
processing circuitry configured to cause the network node to transmit, to a user equipment, a configuration configuring the performing and/or reporting of QoE measurements of the MBS, wherein the configuration indicates that QoE measurements are to be performed or QoE reports are to be reported upon fulfilment of one or more conditions.

44. The network node of claim 43, wherein the one or more conditions comprises:
a particular service type is being transmitted using the MBS; the user equipment has an ability to use certain features for sending QoE reports; and
the user equipment is in a certain radio resource control (RRC) state or that the user equipment transfers to or from a certain RRC state.
